(19) United States
(12) Patent Application Publication
(10) Pub. No.: US 2026/0044989 A1
(43) Pub. Date: Feb. 12, 2026

(54) ADAPTIVE PREDICTOR SELECTION AND ORDERING IN MESH CODING

(71) Applicant: Tencent America LLC, Palo Alto, CA (US)

(72) Inventors: Pranav KADAM, Palo Alto, CA (US); Chao HUANG, Palo Alto, CA (US); Shan LIU, San Jose, CA (US)

(73) Assignee: Tencent America LLC, Palo Alto, CA (US)

(21) Appl. No.: 19/228,558

(22) Filed: Jun. 4, 2025

Related U.S. Application Data
(60) Provisional application No. 63/682,307, filed on Aug. 12, 2024.

(51) Int. Cl. G06T 9/00

(52) U.S. Cl. CPC G06T 9/001

(57) ABSTRACT

A method includes receiving a bitstream including coded information of the one or more meshes. One of (i) a first subset of predictors from a list of candidate predictors and (ii) a first order of predictors in the first subset of predictors used to predict a first attribute associated with a first vertex incident onto a first face in a first mesh of the one or more meshes is determined based on one of (i) a first mesh type of the first mesh and (ii) a first face type of the first face. The first mesh type indicates the most frequent face degree of the first mesh. The first face type indicates a face degree of the first face. The first attribute is predicted based on the determined one of (i) the first subset of predictors and (ii) the first order of predictors in the first subset of predictors.

### INCORPORATION BY REFERENCE

The present application claims the benefit of priority to U.S. Provisional Application No. 63/682,307, “Adaptive Predictor Selection and Ordering in Mesh Coding” filed on Aug. 12, 2024, which is incorporated by reference herein in its entirety.

### TECHNICAL FIELD

The present disclosure describes aspects generally related to mesh processing.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression may help transmit image/video data across different devices, storage and networks with minimal quality degradation. In some examples, video codec technology may compress video based on spatial and temporal redundancy. In an example, a video codec may use techniques referred to as intra prediction that may compress an image based on spatial redundancy. For example, the intra prediction may use reference data from the current picture under reconstruction for sample prediction. In another example, a video codec may use techniques referred to as inter prediction that may compress an image based on temporal redundancy. For example, the inter prediction may predict samples in a current picture from a previously reconstructed picture with motion compensation. The motion compensation may be indicated by a motion vector (MV).

Advances in three-dimensional (3D) capture, modeling, and rendering have promoted 3D content across various platforms and devices. For example, a baby's first step in one continent is captured and grandparents may see (and in some cases interact) and enjoy a full immersive experience with the child in another continent. In order to achieve such realism, models are becoming more sophisticated, and a significant amount of data is linked to the creation and consumption of those models. 3D meshes are widely used to represent such immersive contents.

### SUMMARY

Aspects of the disclosure include methods and apparatuses for mesh processing.

Aspects of the disclosure include a decoding method for decoding one or more meshes. The decoding method includes receiving a bitstream including coded information of the one or more meshes. One of (i) a first subset of predictors from a list of candidate predictors and (ii) a first order of predictors in the first subset of predictors used to predict a first attribute that is associated with a first vertex that is incident onto a first face in a first mesh of the one or more meshes is determined based on one of (i) a first mesh type of the first mesh and (ii) a first face type of the first face. The first mesh type indicates the most frequent face degree of the first mesh. The first face type indicates a face degree of the first face. The first attribute is predicted based on the determined one of (i) the first subset of predictors and (ii) the first order of predictors in the first subset of predictors.

Aspects of the disclosure also provide an apparatus for mesh decoding. The apparatus for mesh decoding including processing circuitry configured to implement any of the described methods including the decoding method of mesh processing performed in a decoder.

In an aspect, a method of mesh encoding such as encoding one or more meshes is provided. The method of mesh encoding includes: determining one of (i) a first subset of predictors from a list of candidate predictors and (ii) a first order of predictors in the first subset of predictors used to predict a first attribute that is associated with a first vertex that is incident onto a first face in a first mesh of the one or more meshes based on one of (i) a first mesh type of the first mesh and (ii) a first face type of the first face. The first mesh type indicates the most frequent face degree of the first mesh. The first face type indicates a face degree of the first face. The first attribute is predicted based on the determined one of (i) the first subset of predictors and (ii) the first order of predictors in the first subset of predictors.

Aspects of the disclosure also provide an apparatus for mesh encoding. The apparatus for mesh encoding including processing circuitry configured to implement any of the described methods of mesh processing performed in an encoder.

In an aspect, a method of processing one or more meshes includes processing a bitstream of the one or more meshes according to a format rule. The bitstream includes coded information of the one or more meshes. The format rule specifies that one of (i) a first subset of predictors from a list of candidate predictors and (ii) a first order of predictors in the first subset of predictors used to predict a first attribute that is associated with a first vertex that is incident onto a first face in a first mesh of the one or more meshes is determined based on one of (i) a first mesh type of the first mesh and (ii) a first face type of the first face. The first mesh type indicates the most frequent face degree of the first mesh. The first face type indicates a face degree of the first face. The format rule specifies that the first attribute is predicted based on the determined one of (i) the first subset of predictors and (ii) the first order of predictors in the first subset of predictors.

Aspects of the disclosure also provide an apparatus for processing one or more meshes. The apparatus for processing including processing circuitry configured to implement any of the described methods of mesh processing.

Aspects of the disclosure also provide a non-transitory computer-readable medium storing instructions which, when executed by a computer, cause the computer to perform any of the described methods for mesh processing.

Technical solutions of the disclosure include aspects directed to more efficiently selecting predictors for polygon mesh compression. In polygon mesh compression, a bitstream may include a value bitstream and a connectivity bitstream, and in some examples, the value bitstream may include a larger portion of the total bitstream compared to the connectivity bitstream. Thus, efficient methods may be used to code the attribute values. In an aspect, mesh characteristics such as a mesh type (e.g., a triangle mesh, a quad mesh, or the like) and/or a face type for meshes with different face degree may be used to select a subset of predictors. In an aspect, predictors in a predictor list may be adaptively ordered to code a predictor index more efficiently. For example, one of (i) a subset of predictors from a list of candidate predictors and (ii) an order of predictors in the subset of predictors is determined based on the mesh characteristics (e.g., (i) a mesh type of the mesh and/or (ii) a face type of a face in the mesh). The subset of predictors may be used to predict an attribute that is associated with a vertex that is incident onto the face in the mesh. The mesh type indicates the most frequent face degree of the mesh. The face type indicates a face degree of the face.

When the subset of predictors is selected based on the mesh characteristics, the subset of predictors that is selected may be more suitable in predicting the mesh or certain faces in the mesh. Thus, the prediction may be more accurate and/or more efficient.

When the order of the predictors in the subset of predictors is determined based on the mesh characteristics, the predictor that is more frequently used in predicting meshes with the mesh characteristics or faces with certain face degrees may be ranked higher in the subset of predictors. Thus, less bits may be used to signal a predictor index associated with the predictor. Accordingly, signaling the predictor index may be more efficient.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of an encoding process for mesh processing based on a related video codec according to an aspect of the disclosure.

FIG. 5 shows an example of a decoding process for mesh processing according to an aspect of the disclosure.

FIG. 6 shows an example of a vertex degree of a vertex and a face degree of a face of a polygon mesh according to an aspect of the disclosure.

FIG. 7 shows an example of a parallelogram prediction according to an aspect of the disclosure.

FIGS. 8-9 show examples of predicting a vertex using two references according to an aspect of the disclosure.

FIG. 10 shows a flow chart outlining a decoding process according to some aspects of the disclosure.

FIG. 11 shows a flow chart outlining an encoding process according to some aspects of the disclosure.

FIG. 12 is a schematic illustration of a computer system in accordance with an aspect.

### DETAILED DESCRIPTION

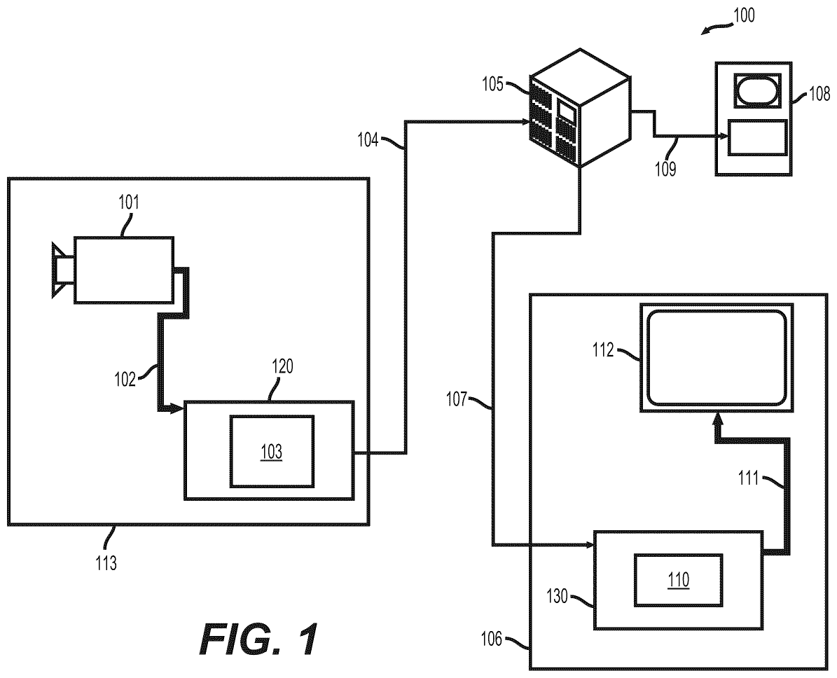

FIG. 1 shows a block diagram of a video processing system (100) in some examples. The video processing system (100) is an example of an application for the disclosed subject matter, a video encoder and a video decoder in a streaming environment. The disclosed subject matter may be equally applicable to other image and/or video enabled applications, including, for example, video conferencing, digital TV, streaming services, storing of compressed video on digital media including CD, DVD, memory stick, and the like.

The video processing system (100) includes a capture subsystem (113), that may include a video source (101). The video source (101) may include one or more images captured by a camera and/or generated by a computer. For example, a digital camera may create a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), may be processed by an electronic device (120) that includes a video encoder (103) coupled to the video source (101). The video encoder (103) may include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), may be stored on a streaming server (105) for future use. One or more streaming client subsystems, such as client subsystems (106) and (108) in FIG. 1 may access the streaming server (105) to retrieve copies (107) and (109) of the encoded video data (104). A client subsystem (106) may include a video decoder (110), for example, in an electronic device (130). The video decoder (110) decodes the incoming copy (107) of the encoded video data and creates an outgoing stream of video pictures (111) that may be rendered on a display (112) (e.g., display screen) or other rendering device (not depicted). In some streaming systems, the encoded video data (104), (107), and (109) (e.g., video bitstreams) may be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) may include other components (not shown). For example, the electronic device (120) may include a video decoder (not shown) and the electronic device (130) may include a video encoder (not shown) as well.

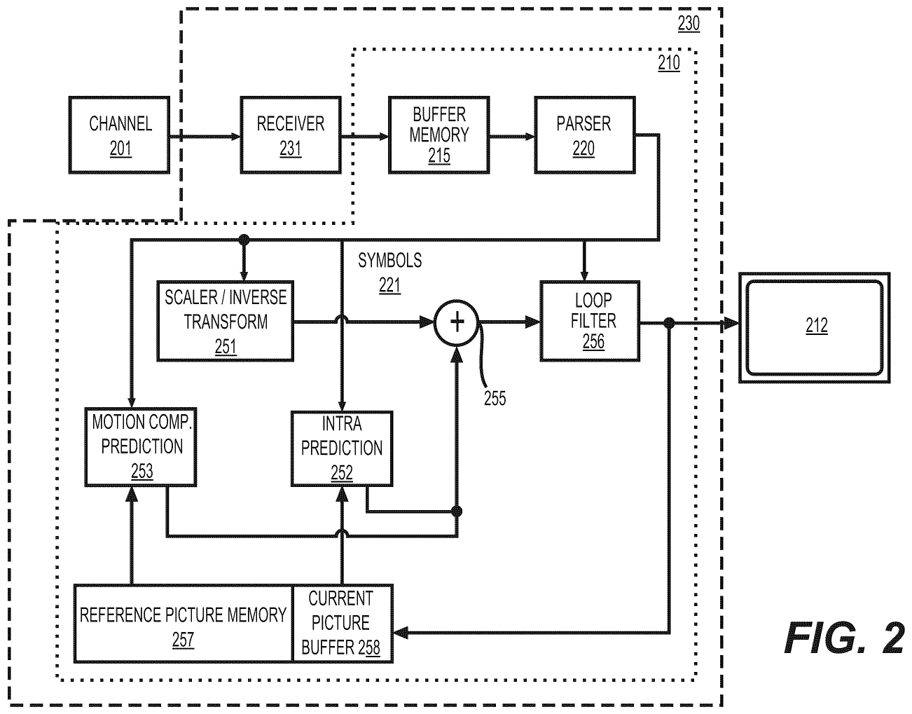

FIG. 2 shows an example of a block diagram of a video decoder (210). The video decoder (210) may be included in an electronic device (230). The electronic device (230) may include a receiver (231). The receiver (231) may include receiving circuitry, such as network interface circuitry. The video decoder (210) may be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it may be outside of the video decoder (210) (not depicted). In still others, there may be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or may be small. For use on best effort packet networks such as the Internet, the buffer memory (215) may be required, may be comparatively large and may be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but may be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence may be in accordance with a video coding technology or standard, and may follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups may include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) may involve multiple different units depending on the type of the coded video picture or parts thereof (such as: inter and intra picture, inter and intra block), and other factors. Which units are involved, and how, may be controlled by subgroup control information parsed from the coded video sequence by the parser (220). The flow of such subgroup control information between the parser (220) and the multiple units below is not depicted for clarity.

Beyond the functional blocks already mentioned, the video decoder (210) may be conceptually subdivided into a number of functional units as described below. In a practical implementation operating under commercial constraints, many of these units interact closely with each other and may, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) may output blocks comprising sample values, that may be input into aggregator (255).

In some cases, the output samples of the scaler/inverse transform unit (251) may pertain to an intra coded block. The intra coded block is a block that is not using predictive information from previously reconstructed pictures, but may use predictive information from previously reconstructed parts of the current picture. Such predictive information may be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) may pertain to an inter coded, and potentially motion compensated, block. In such a case, a motion compensation prediction unit (253) may access reference picture memory (257) to fetch samples used for prediction. After motion compensating the fetched samples in accordance with the symbols (221) pertaining to the block, these samples may be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples may be controlled by motion vectors, available to the motion compensation prediction unit (253) in the form of symbols (221) that may have, for example X, Y, and reference picture components. Motion compensation also may include interpolation of sample values as fetched from the reference picture memory (257) when sub-sample exact motion vectors are in use, motion vector prediction mechanisms, and so forth.

The output samples of the aggregator (255) may be subject to various loop filtering techniques in the loop filter unit (256). Video compression technologies may include in-loop filter technologies that are controlled by parameters included in the coded video sequence (also referred to as coded video bitstream) and made available to the loop filter unit (256) as symbols (221) from the parser (220). Video compression may also be responsive to meta-information obtained during the decoding of previous (in decoding order) parts of the coded picture or coded video sequence, as well as responsive to previously reconstructed and loop-filtered sample values.

The output of the loop filter unit (256) may be a sample stream that may be output to the render device (212) as well as stored in the reference picture memory (257) for use in future inter-picture prediction.

Certain coded pictures, once fully reconstructed, may be used as reference pictures for future prediction. For example, once a coded picture corresponding to a current picture is fully reconstructed and the coded picture has been identified as a reference picture (by, for example, the parser (220)), the current picture buffer (258) may become a part of the reference picture memory (257), and a fresh current picture buffer may be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile may select certain tools as the only tools available for use under that profile from all the tools available in the video compression technology or standard. Also necessary for compliance may be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels may, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data may be in the form of, for example, temporal, spatial, or signal noise ratio (SNR) enhancement layers, redundant slices, redundant pictures, forward error correction codes, and so on.

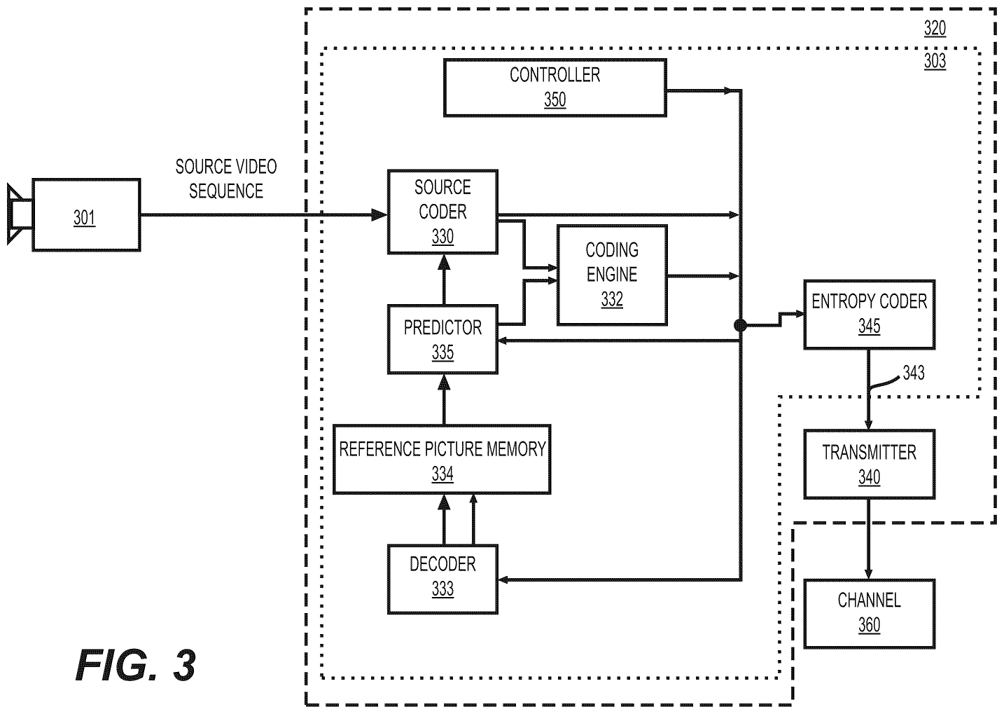

FIG. 3 shows an example of a block diagram of a video encoder (303). The video encoder (303) is included in an electronic device (320). The electronic device (320) includes a transmitter (340) (e.g., transmitting circuitry). The video encoder (303) may be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that may be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel may include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) may include rate control related parameters (picture skip, quantizer, lambda value of rate-distortion optimization techniques, . . . ), picture size, group of pictures (GOP) layout, maximum motion vector search range, and so forth. The controller (350) may be configured to have other suitable functions that pertain to the video encoder (303) optimized for a certain system design.

In some aspects, the video encoder (303) is configured to operate in a coding loop. As an oversimplified description, in an example, the coding loop may include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity may not be maintained, for example because of channel errors) is used in some related arts as well.

The operation of the “local” decoder (333) may be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) may be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies may be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures. ” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:
An Intra Picture (I picture) may be coded and decoded without using any other picture in the sequence as a source of prediction. Some video codecs allow for different types of intra pictures, including, for example Independent Decoder Refresh (“IDR”) Pictures.
A predictive picture (P picture) may be coded and decoded using intra prediction or inter prediction using at most one motion vector and reference index to predict the sample values of each block.
A bi-directionally predictive picture (B Picture) may be coded and decoded using intra prediction or inter prediction using two motion vectors and reference indices to predict the sample values of each block. Similarly, multiple-predictive pictures may use more than two reference pictures and associated metadata for the reconstruction of a single block.

Aspect of the present disclosure may also be applied to variants of I pictures, P pictures, and B pictures, and their respective applications and features.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks'respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence.

Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture may be coded by a vector that is referred to as a motion vector. The motion vector points to the reference block in the reference picture, and may have a third dimension identifying the reference picture, in case multiple reference pictures are in use.

In some aspects, a bi-prediction technique may be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture may be coded by a first motion vector that points to a first reference block in the first reference picture, and a second motion vector that points to a second reference block in the second reference picture. The block may be predicted by a combination of the first reference block and the second reference block.

Further, a merge mode technique may be used in the inter-picture prediction to improve coding efficiency.

According to some aspects of the disclosure, predictions, such as inter-picture predictions and intra-picture predictions, are performed in the unit of blocks, such as a polygon-shaped or triangular block. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU may be recursively quadtree split into one or multiple coding units (CUs). For example, a CTU of 64×64 pixels may be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) may be implemented using any suitable technique. In an aspect, the video encoders (103) and (303) and the video decoders (110) and (210) may be implemented using one or more integrated circuits. In another aspect, the video encoders (103) and (303), and the video decoders (110) and (210) may be implemented using one or more processors that execute software instructions.

The disclosure includes aspects related to methods and apparatuses to predict vertex positions and/or texture coordinates by reflections, parallelogram predictions, and/or the like for mesh compression such as polygon mesh compression. For example, reflection prediction and/or parallelogram predictions of positions and/or UV coordinates in mesh compression such as polygon mesh compression are disclosed.

A mesh may include a plurality of polygons (such as a plurality of polygonal faces) that may describe a surface of a volumetric object. For example, the surface of the volumetric object may be approximated using the mesh. Each polygon of the mesh may be defined by vertices of the corresponding polygon in a three-dimensional (3D) space and information of how the vertices are connected, which may be referred to as connectivity information. In some aspects, vertex attributes, such as colors, normals, displacements, and the like, may be associated with the vertices (also referred to as the mesh vertices). Attributes (also referred to as vertex attributes) may also be associated with the surface of the mesh by exploiting mapping information that parameterizes the mesh with two-dimensional (2D) attribute maps. Such mapping may be described by a set of parametric coordinates, referred to as UV coordinates or texture coordinates, associated with the mesh vertices. 2D attribute maps may be used to store high resolution attribute information such as texture, normals, displacements, and the like. The high resolution attribute information may be used for various purposes such as texture mapping, shading, and mesh reconstruction.

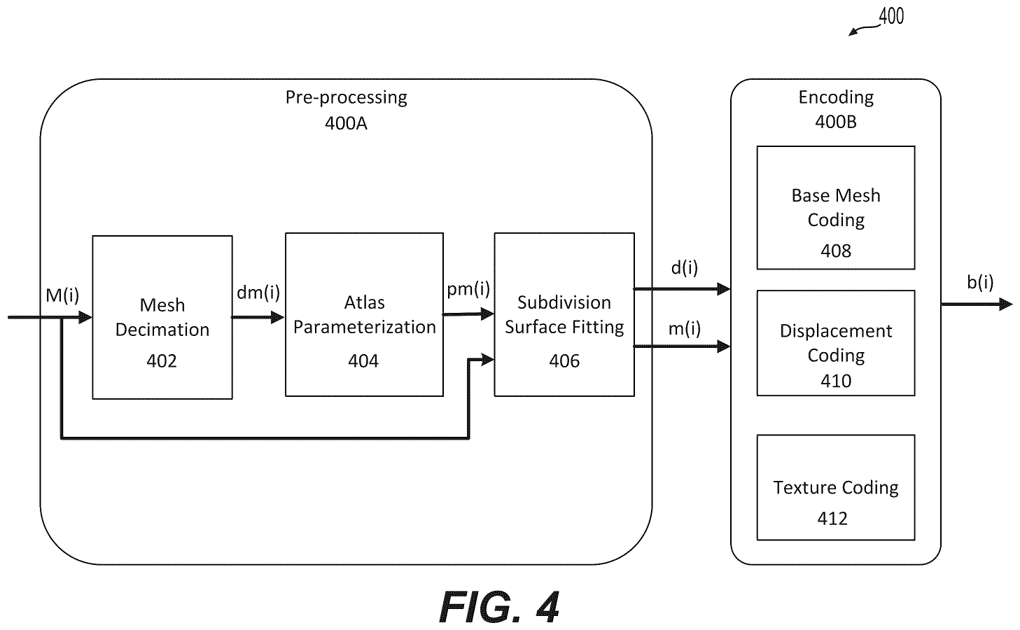

FIG. 4 shows an example of an encoding process (400) for mesh processing based on a related video codec according to an aspect of the disclosure. As shown in FIG. 4, the encoding process (400) may include a pre-processing step (400A) and an encoding step (400B). The pre-processing step (400A) may be configured to generate a base mesh m(i) of a current frame and a displacement field d(i) of the current frame that includes displacement vectors according to an input mesh M(i) of the current frame. The encoding step (400B) may be configured to encode the base mesh m(i), the displacement field d(i), and texture information of the base mesh m(i). The displacement field d(i) of the current frame may include displacement vectors. An index i may refer to the current frame. In an aspect, a mode decision method may be performed in the encoding process (400) to determine whether inter coding (also referred to as inter frame prediction or an inter mode), intra coding (also referred to as intra frame prediction or an intra mode), or the like is applied to the current frame. For example, the mode decision method may compare a cost of an intra mode and a cost of an inter mode and decide a coding mode of the base mesh m(i) of the current frame based on which one of the costs is smaller. In some examples, a skip mode is used to code (e.g., encode or decode) the base mesh m(i). In an example, the skip mode is a special mode of the inter mode. For example, the base mesh m(i) may be intra coded, or inter coded, or coded with the SKIP mode.

Still referring to FIG. 4, the pre-processing step (400A) may include a mesh decimation process (402), a parameterization process such as an atlas parameterization process (404), and a subdivision surface fitting process (406). The mesh decimation process (402) is configured to down-sample vertices of the input mesh M(i) to generate a decimated mesh dm(i) that may include a plurality of decimated (or down-sampled) vertices. A number of the plurality of decimated vertices is less than a number of the vertices of the input mesh M(i). The parameterization process such as the atlas parameterization process (404) is configured to map the decimated mesh dm(i) onto a planar domain, such as onto a UV atlas (or a UV map), to generate a re-parameterized mesh pm(i). In an example, the atlas parameterization may be performed based on a video processing tool, such as a UV Atlas tool. The subdivision surface fitting process (406) is configured to take the re-parameterized mesh pm(i) and the input mesh M(i) as inputs and produce a based mesh m(i) together with the displacement field d(i) that includes the displacement vectors or a set of displacements. In an example of the subdivision surface fitting process (406), pm(i) is subdivided by using a subdivision scheme such as an iterative interpolation to obtain a subdivided mesh. The iterative interpolation includes inserting at each iteration a new point in a middle of each edge of the re-parameterized mesh pm(i). Any suitable subdivision scheme may be applied to subdivide pm(i). The displacement field d(i) is computed by determining a nearest point on a surface of the input mesh M(i) for each vertex of the subdivided mesh.

An advantage of the subdivided mesh may include that the subdivided mesh has a subdivision structure that allows efficient compression, while offering a faithful approximation of the input mesh. The compression efficiency may be obtained due to the following properties. The decimated mesh dm(i) may have a low number of vertices and may be encoded and transmitted using a lower number of bits than the input mesh M(i) or the subdivided mesh. Referring to FIG. 4, the base mesh m(i) may be generated from the decimated mesh dm(i). In an example, the base mesh m(i) is the decimated mesh dm(i). As the subdivided mesh may be generated based on the subdivision method, the subdivided mesh may be automatically generated by the decoder when the base mesh or the decimated mesh is decoded (e.g., there is no need to use any information other than the subdivision scheme and a subdivision iteration count). At the decoder side, the displacement field d(i) may be generated by decoding the displacement vectors associated with the vertices of the subdivided mesh. Besides allowing for spatial/quality scalability, the subdivision structure enables efficient transforms, such as wavelet decomposition, which can offer high compression performance.

The encoding step (400B) may include a base mesh coding (408), a displacement coding (410), a texture coding (412), and the like. The base mesh coding (408) is configured to encode geometric information of the base mesh m(i) associated with the current frame. In an intra encoding, the base mesh m(i) may be first quantized (e.g., using uniform quantization) and then encoded, for example, by the coding mode determined using the mode decision method. The coding mode may be the inter mode, the intra mode, the skip mode, or the like. The encoder used to intra code the base mesh m(i) may be referred to as a static mesh encoder. In the inter encoding, a reference base mesh (e.g., a reconstructed quantized reference base mesh m′(j)) associated with a reference frame indicated by an index j may be used to predict the base mesh m(i) associated with the current frame indicated by the index i. The displacement coding (410) is configured to encode the displacement field d(i) that is generated in the pre-processing step (400A). The displacement field d(i) may include a set of displacement vectors (or displacements) associated with the subdivided mesh vertices. The texture coding (412) is configured to encode attribute information of the base mesh m(i). The attribute information may include texture, normal, color, and/or the like. The attribute information may be encoded based on a suitable codec, such as High-Efficiency Video Coding (HEVC) or Versatile Video Coding (VVC).

In an aspect, referring to FIG. 4, a mesh encoding process such as the encoding process (400) starts with a pre-processing (e.g., the pre-processing step (400A)). The pre-processing may convert the input mesh M(i) into the base mesh m(i) together with the displacement field d(i) including a set of displacements (or a set of displacement vectors). The encoding step (400B) may compress outputs (e.g., m(i), d(i), and the like) from the pre-processing and generate a compressed bitstream b(i). The compressed bitstream b(i) may include a compressed base mesh bitstream, a compressed displacement field bitstream (also referred to as a compressed displacement bitstream), a compressed attribute bitstream, and/or the like.

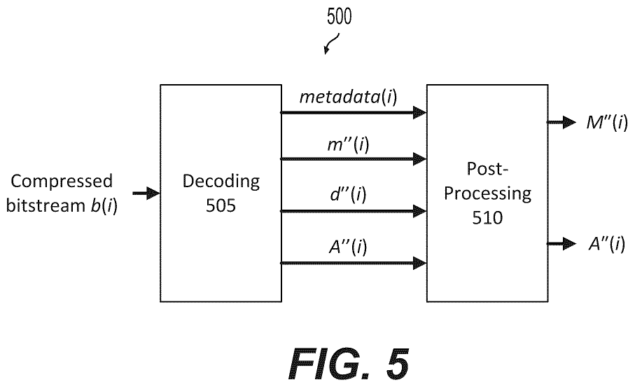

FIG. 5 shows an example of a decoding process (500) for mesh processing according to an aspect of the disclosure. The decoding process (500) may include a decoding step (505) and a post-processing step (510). A compressed bitstream b(i) may be fed to the decoding step (505). In an example, for a lossless transmission, the compressed bitstream b(i) is the output b(i) from the encoding process (400). The decoding step (505) may extract various sub-bitstreams such as the compressed base mesh sub-stream, the compressed displacement field sub-stream, the compressed attribute sub-stream, and/or the like. The decoding step (505) may decompress the sub-bitstreams to generate the following components: patch metadata indicated by metadata(i), a decoded base mesh m″(i), a decoded displacement field (including displacements) d″(i), a decoded attribute map A″(i), and/or the like.

In an aspect, the base mesh sub-stream may be fed to a mesh decoder to generate a reconstructed quantized base mesh m′(i). The decoded base mesh m″(i) may be obtained by applying an inverse quantization to m′(i). The displacement field sub-stream including packed and quantized wavelet coefficients that are encoded may be decoded by a video and/or image decoder. Image unpacking and inverse quantization may be applied to the packed quantized wavelet coefficients that are reconstructed to obtain the unpacked and dequantized transformed coefficients (e.g., wavelet coefficients). An inverse wavelet transform may be applied to the unpacked and dequantized wavelet coefficients to generate the decoded displacement field d″(i).

The decoded components (e.g., including metadata(i), m″(i), d″(i), A″(i), and/or the like) may be fed to a post-processing step (510). A mesh (also referred to as a decoded mesh) M″(i) may be generated by the post-processing step (510) based on m″(i) and d″(i). In an example, the reconstructed deformed mesh DM(i) may be obtained by subdividing m″(i) using a subdivision scheme and applying the reconstructed displacements d″(i) to vertices of a subdivided mesh. In an example, when the encoding process (400), the decoding process (500), and the transmission are lossless, the mesh M″(i) may be the same as the input mesh M(i). When one of the encoding process (400), the decoding process (500), and the transmission is lossy, M″(i) is different from M(i). In various examples, the difference, if any, between M″(i) and M(i) is relatively small. In an example, an attribute map A″(i) is also generated by the post-processing step (510).

A polygon mesh (also interchangeably referred to as a polygonal mesh) may include topologic quantities, such as vertices, edges, and faces, and geometric quantities, such as attributes including vertex positions, face colors, and the like. Connectivity information of a polygon mesh may describe incidences between elements and may be implied by the topology. For example, two vertices are adjacent when an edge is incident to the two vertices. For example, two faces are adjacent when an edge is incident to the two faces.

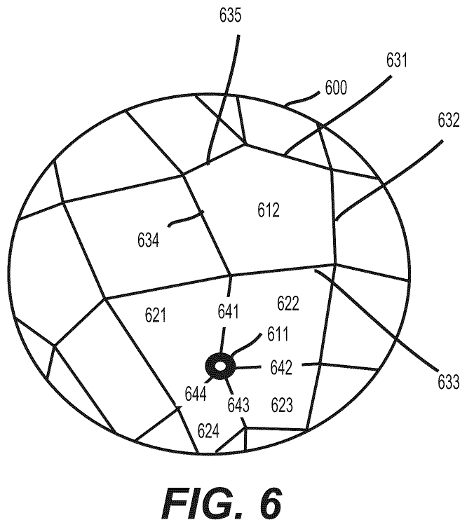

FIG. 6 shows an example of a vertex degree of a vertex (611) and a face degree of a face (612) of a polygon mesh (600) according to an aspect of the disclosure. The polygon mesh (600) may include a plurality of faces that includes the face (612). The polygon mesh (600) may include a plurality of vertices that includes the vertex (611). In an aspect, a vertex degree of a vertex may be interchangeably referred to as a valence of the vertex. A vertex degree of a vertex may specify a number of edges incident to the vertex. Referring to FIG. 6, the vertex degree of the vertex (611) may specify a number of edges (641)-(644) incident to the vertex (611), and the vertex degree of the vertex (611) is 4. A face degree of a face may specify a number of incident edges of the face. Referring to FIG. 6, the face degree of the face (612) may specify a number of incident edges (631)-(635) of the face (612), and the face degree of the face (612) is 5.

In some embodiments, a mesh can include information such as geometry information, connectivity information, mapping information, attributes, and the like. In an aspect, attributes may include vertex attributes and attribute maps. In some examples, the geometry information is described by a set of 3D positions associated with the vertices of the mesh. In an example, (x, y, z) coordinates can be used to describe the 3D positions of the vertices, and are also referred to as 3D coordinates. Referring to FIG. 6, an example of the vertices is the vertex (611). In some examples, the connectivity information includes a set of vertex indices that describes how to connect the vertices to create a 3D surface. In some examples, the mapping information describes how to map the mesh surface to 2D regions of the plane. In an example, the mapping information is described by a set of UV parametric/texture coordinates (u, v) associated with the mesh vertices together with the connectivity information. In some examples, the vertex attributes include scalar or vector attribute values associated with the mesh vertices. In some examples, attribute maps include attributes that are associated with the mesh surface and are stored as 2D images/videos. In an example, the mapping between the videos (e.g., 2D images/videos) and the mesh surface is defined by the mapping information.

In an aspect, UV mapping or mesh parameterization may be used to map faces of a mesh in the 3D domain to the 2D domain. In some examples, a mesh is cut into patches (also referred to as patch components) in the 3D domain. A patch is a contiguous subset of the mesh with a boundary formed of boundary edges. A boundary edge of a patch is an edge that belongs to only one polygon of the patch, and is not shared by two adjacent polygons in the patch.

Vertices of boundary edges in a patch are referred to as boundary vertices of the patch, and non-boundary vertices in a patch can be referred to as interior vertices of the patch in some examples.

In an aspect, the patches are parameterized respectively into 2D shapes (also referred to as UV patches, 2D patches, or UV charts) in some examples. The 2D shapes can be packed (e.g., oriented and placed) into a map that is also referred to as a UV atlas in some examples. In some examples, the map can be further processed using 2D image or video processing techniques.

In an example, a UV mapping technique generates a UV atlas (also referred to as UV map) and one or more texture atlas (also referred to as texture map) in 2D corresponding to patches of a 3D mesh. The UV atlas includes assignments of 3D vertices of the 3D mesh to 2D points in a 2D domain (e.g., a rectangular). The UV atlas is a mapping between coordinates of the 3D surface to coordinates of 2D domain. In an example, a point in the UV atlas at a 2D coordinates (u, v) has a value that is formed by coordinates (x, y, z) of a vertex in the 3D domain. In an example, a texture atlas includes color information of the 3D mesh. For example, a point in the texture atlas at the 2D coordinates (u, v) (which has a 3D value of (x, y, z) in the UV atlas) has a color that specifies the color attribute of a point at (x, y, z) in the 3D domain. In some examples, the coordinates (x, y, z) in the 3D domain are referred to as 3D coordinates, or xyz coordinates, and the 2D coordinates (u, v) are referred to as uv coordinates or UV coordinates. In an example, a position of a vertex (e.g., the vertex (611)) in a mesh such as the polygon mesh (600) is indicated by the 3D coordinate (x, y, z), the vertex may correspond to a 2D point in a 2D map or the UV map (e.g., the vertex may be mapped to the 2D point in the UV map), and a position of the 2D point may be indicated by the UV coordinate (u, v).

Mesh compression may include connectivity and/or topology coding and attribute value coding (e.g., value coding for each attribute). The attributes can include positions, texture coordinates, normal, and the like. A predictive coding scheme may be used to code (e.g., encode and/or decode) the attributes where a residue between an original attribute and a predicted attribute may be entropy coded. In an aspect, a set of candidate predictors may be available, and an optimal predictor index may be signaled alongside. A lossless mesh coding format such as Draco may be used, for example, for 2-manifold meshes. In an example, an edge can only be shared by at most two faces in a 2-manifold mesh. Static polygonal meshes may be coded using lossless and lossy coding. For example, VVM (Versatile Video Coding for Meshes) is an ongoing mesh coding standard aimed at both lossless and lossy compression of static polygonal meshes.

In an example, to code the values of the position and UV attributes, prediction schemes may be utilized. For example, the value of each position of mesh vertices in a mesh (e.g., a 3D mesh) or UV coordinates may be predicted by using a fixed value (e.g., zeros or centroids), a value of a previous position or a previous UV coordinate, an average of last n positions or an average of last n UV coordinates, parallelogram prediction(s), reflection prediction(s), and/or the like.

A parallelogram prediction may refer to a prediction based on a parallelogram.

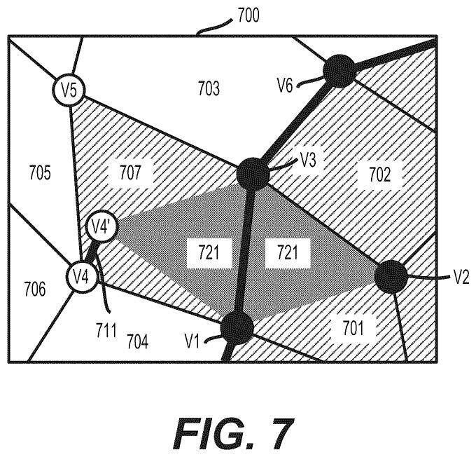

According to an aspect of a parallelogram prediction, a position of a point may be predicted to complete a parallelogram formed by three points of a neighboring triangle. Referring to FIG. 7, positions of three points V1-V3 are already determined (e.g., the positions of V1-V3 are known), and a position of a point V4 is predicted using a parallelogram prediction. According to the parallelogram prediction, the position of V4 may be predicted by completing a parallelogram (721) that are formed by V1-V3 and a predicted point V4′. Thus, a predicted position of V4 is a position of the predicted point V4′. In an example, a prediction residual indicating a difference between the positions of V4 and V4′ (e.g., the actual position of V4 and the predicted position of V4), such as a vector (711), may be referred to as a corrective vector (711). The prediction residual (e.g., the vector (711)) may be stored, encoded, and/or sent to a decoder. Prediction residuals may be encoded using entropy coding, for example, at an encoder side. At a decoder side, the prediction residuals may be decoded using entropy decoding. For example, the prediction residuals may include a sequence of correctors, which may spread around a zero vector and may be compressed more compactly than a sequence of positions.

A parallelogram prediction may be applied to predict a position of a point based on positions of three points, for example, the three points whose positions are already determined. In an aspect, the points may be vertices in a mesh, such as vertices in a polygon mesh. The mesh may be a 3D mesh. Parallelogram predictions may be applied to predict a position of a vertex in a mesh based on positions of three vertices in the mesh that are already determined.

In an aspect, the points may be 2D points in a 2D map where the 2D map is associated with a mesh such as a 3D mesh. For example, the 2D map may be determined based on the 3D mesh. Positions of the 2D points may be indicated by 2D coordinates such as UV coordinates. Parallelogram predictions may be applied to predict a position of a 2D point in a 2D map based on positions of three 2D points in the 2D map that are already determined. For purposes of brevity, the descriptions in some examples are given using vertices in a mesh, and the descriptions may be suitably adapted for 2D points in a 2D map to predict the positions of the 2D points.

FIG. 7 shows an example of a portion of a mesh (700). The mesh (700) may include a plurality of faces (701)-(707) and the like. The mesh (700) may include a plurality of vertices V1-V6 and the like. For example, the vertices V1-V3 are incident to the face (701). The vertices V2, V3, and V6 are incident to the face (702). The vertices V3, V5, and V6 are incident to the face (703). The vertices V1 and V4 are incident to the face (704). The vertices V1 and V3-V5 are incident to the face (707).

Referring to FIG. 7, the black vertices V1-V3 and V6 are visited vertices, for example, the vertices V1-V3 and V6 are already processed, and the white vertices V4-V5 are not visited yet (also referred to as unknown vertices). In the example of FIG. 7, the vertex V4 is being visited, for example, the position of the vertex V4 is being predicted based on the positions of the vertices V1-V3 using the parallelogram prediction as described above. In FIG. 7, the vertices V1-V3 that are used to predict the position of V4 are incident to the face (701) and the vertex V4 that is being predicted is incident to the face (707) that is different from the face (701). Thus, the parallelogram prediction in FIG. 7 is referred to as the across-parallelogram prediction, for example, indicating that the parallelogram prediction in FIG. 7 is across multiple faces such as the faces (701) and (707). In an example, the multiple faces are neighboring faces. The parallelogram (721) is across the faces (701) and (707).

In an aspect, mesh characteristics of a mesh may include a mesh type (also referred to as a type of the mesh) of the mesh, a face type of a face in the mesh, and the like.

In an aspect, the mesh type may indicate the most frequent face degree of the mesh. The mesh may include faces having respective face degrees, and the most frequent face degree of the mesh has the highest occurrence in the face degrees of the respective faces in the mesh. In an example, the face degree of each face in the mesh is equal, and the face degree of each face in the mesh is equal to the most frequent face degree of the mesh. For example, a face degree of each face in a triangle mesh is 3 and is the same, and the mesh type indicates that the mesh is a triangle mesh and/or the most frequent face degree of the mesh is 3. A face degree of each face in a quadrilateral mesh (or a quad mesh) is 4 and is the same. In an example, the face degrees of the respective faces in the mesh are different, for example, a number of different face degrees of the respective faces in the mesh is greater than one.

In an aspect, a face type of a face in the mesh may indicate a face degree of the face in the mesh.

In some examples, such as in some examples of VVM, mesh characteristics are not fully exploited when selecting the predictors. In some examples, a first group of predictors are more suitable for triangle meshes and a second group of predictors may be more suited for higher polygonal meshes. In an example, the second group of predictors is different from the first group of predictors. In an example, a higher polygonal mesh refers to a polygonal mesh where a face degree of each face is at least 5.

In some examples, an order of predictors in a predictor list is fixed. Depending on a predictor index coding strategy, it may be suboptimal if predictors lower in the predictor list (e.g., predictor indices associated with the predictors lower in the predictor list are larger than predictor indices associated with predictors higher in the predictor list) are more frequently used.

According to an aspect of the disclosure, mesh characteristics such as a type of a mesh (e.g., a triangle mesh, a quad mesh, or the like) and/or a face type for the mesh with different face degrees can be used to select a set of predictors (e.g., an optimal set of predictors). In an aspect, the predictors in the predictor list may be adaptively ordered so that predictor indices may be coded more efficiently. For example, one or more predictors that are used more frequently may be indicated by predictor indices having smaller numbers.

Methods described in the disclosure may be applied to any geometry and/or attribute encoding for arbitrary polygon meshes and irrespective of a traversal algorithm used. The methods may be used separately or in combination of any form.

According to an aspect of the disclosure, a first mesh in one or more meshes may be coded based on mesh characteristics such as a mesh type of the first mesh, a face type of a face in the first mesh, and/or the like. A first mesh type may indicate the most frequent face degree of the first mesh, such as the first mesh being a triangle mesh, a quad mesh, or the like. A first face type may indicate a face degree of the first face. A first attribute that is associated with a first vertex that is incident onto a first face in the first mesh of the one or more meshes may be predicted as described below. One of (i) a first subset of predictors from a list of candidate predictors such as a list of Ncandidate predictors [pre d₁, pre d₂, . . . , pre d_{N}] and (ii) a first order of predictors in the first subset of predictors used to predict the first attribute may be determined based on one of (i) a first mesh type of the first mesh and (ii) a first face type of the first face. The first attribute may be predicted based on the determined one of (i) the first subset of predictors and (ii) the first order of predictors in the first subset of predictors.

In an aspect, the predictors (e.g., the first subset of predictors) may be selected based on the type of mesh (e.g., the first mesh type of the first mesh). For example, from the list of N candidate predictors [pre d₁, pre d₂, . . . , pre d_{N}], a subset of N_{T1} predictors may be used when coding (e.g., encoding and/or decoding) triangle meshes. A subset of N_{Q1} predictors may be used when coding (e.g., encoding and/or decoding) quad meshes. N_{T1} may or may not be equal to N_{Q1}. Some or no predictors for the triangle meshes may overlap with the predictors for the quad meshes. The subset of N_{Q1} predictors may be different from the subset of N_{T1} predictors. In an example, one or more predictors in the subset of N_{Q1} predictors are different from predictors in the subset of N_{T1} predictors. In an example, each predictor in the subset of N_{Q1} predictors is different from the predictors in the subset of N_{T1} predictors. In an example, the first subset of predictors (e.g., the subset of N_{T1} predictors) is determined from the list of candidate predictors based on the first mesh type of the first mesh (e.g., the first mesh type indicates that the first mesh is a triangle mesh). In an example, a face degree (e.g., 3) of each face in the first mesh is equal to the most frequent face degree (e.g., 3) of the first mesh.

In an aspect, the predictors (e.g., the first subset of predictors) may be selected based on the most frequent face degree for the first mesh when faces of the first mesh have multiple face degrees. In an example, face degrees of respective faces in the first mesh are different. For example, a number of different face degrees of the respective faces in the first mesh is greater than one. The most frequent face degree of the first mesh has the highest occurrence in the face degrees of the respective faces in the first mesh. In an example, the first mesh is a tri-quad mesh including first faces having a face degree of 3 and second faces having a face degree of 4. For example, from the list of Ncandidate predictors [pre d₁, pre d₂, . . . , pre d_{N}], a subset of N_{T2} predictors may be used when coding (e.g., encoding and/or decoding) the tri-quad mesh where the most frequent face degree is 3 (e.g., a number of the first faces having the face degree of 3 is larger than a number of the second faces having the face degree of 4). A subset of N_{Q2} predictors may be used when coding (e.g., encoding and/or decoding) the tri-quad mesh where the most frequent face degree is 4 (e.g., the number of the first faces having the face degree of 3 is less than the number of the second faces having the face degree of 4). N_{T2} may or may not be equal to N_{Q22}. Some or no predictors for the tri-quad meshes with different face degrees may overlap. The subset of N_{Q2} predictors may be different from the subset of N_{T2} predictors. In an example, one or more predictors in the subset of N_{Q2} predictors are different from predictors in the subset of N_{T2} predictors. In an example, each predictor in the subset of N_{Q2} predictors is different from the predictors in the subset of N_{T2} predictors.

In an example, the one or more meshes include the first mesh and a second mesh. A second subset of predictors from the list of candidate predictors may be determined based on a second mesh type of the second mesh. When the second mesh type is different from the first mesh type, the second subset of predictors is different from the first subset of predictors.

In an aspect, a face level decision may be made to select which predictors to use. For example, from the list of Ncandidate predictors [pre d₁, pre d₂, . . . , pre d_{N}], a subset of N_{T3} predictors may be used to predict an attribute from available references when the attribute to be coded (e.g., encoded or decoded) belong to a face having a first face degree (e.g., a triangle face). A subset of N_{Q3} predictors may be used to predict an attribute from available references when the references and the attribute to be coded (e.g., encoded or decoded) belong to a face having a second face degree (e.g., a quad face). In an example, the first face degree is different from the second face degree. N_{T3} may or may not be equal to N_{Q3}. Some or no predictors for a triangle face may overlap with the predictors for a quad face.

In an example, the first subset of predictors (e.g., the subset of N_{T3} predictors) from the list of candidate predictors is determined based on the face degree (e.g., 3) of the first face. In an example, a second subset of predictors (e.g., the subset of N_{Q3} predictors, the subset of N_{Q3} predictors, or the like) is determined from the list of candidate predictors based on a face degree (e.g., 4) of a second face in the first mesh. When the face degree of the second face is different from the face degree of the first face, the second subset of predictors is different from the first subset of predictors.

In an example, the attribute (e.g., a vertex attribute) is associated with a vertex. The vertex may be shared by faces with different face degrees, such as a first face having a first face degree (e.g., 3) and a second face having a second face degree (e.g., 4). In this case, the first subset of predictors used to predict the vertex may be selected based on either the first face degree or the second face degree.

In an aspect, the predictors in the predictor list (e.g., the first subset of predictors or the list of N predictors) may be ordered based on the mesh type (e.g., a triangle mesh, a quad mesh, a tri-quad mesh). In an example, the first order of predictors in the first subset of predictors is determined based on the first mesh type of the first mesh. In an example, a second order of predictors in a second subset of predictors from the list of candidate predictors is determined based on the second mesh type of the second mesh. When the second mesh type is different from the first mesh type, the second order of predictors is different from the first order of predictors. In an example, a third order of predictors in the first subset of predictors is determined based on the second mesh type of the second mesh. When the second mesh type is different from the first mesh type, the third order of predictors is different from the first order of predictors. Accordingly, the optimal predictors for a given mesh type may be kept on the top of the predictor list. In an example, four predictors pre d₁, pre d₂, pre d₃, pre d₄ are available. In an example, the predictor list for a triangle mesh is [pre d₂, pre d₃, pre d₁, pre d₄] and the predictor list for a quad mesh is [pre d₄, pre d₃, pre d₂, pre d₁] if pre d₂ is a more favorable predictor for triangle meshes and pre d₄ is more suitable for quad meshes. In an example, the face degree of each face in the first mesh is equal to the most frequent face degree of the first mesh.

In an example, the face degrees of the respective faces in the first mesh are different, for example, a number of different face degrees of the respective faces in the first mesh is greater than one, and the most frequent face degree of the first mesh has the highest occurrence in the face degrees of the respective faces in the first mesh and the predictors in the predictor list may be ordered based on the most frequent face degree. For example, the predictor list for a tri-quad mesh with the most frequent face degree of 3 is [pre d₂, pre d₃, pre d₁, pre d₄], and the predictor list for a tri-quad mesh with the most frequent face degree of 4 is [pre d₄, pre d₃, pre d₂, pre d₁].

Ordering predictors based on the mesh type may make coding predictor indices more efficient as the more frequently used predictors correspond to predictor indices with smaller numbers, and the predictor indices with smaller numbers may be coded using less bits.

In an aspect, the predictors in the predictor list may be ordered on a face level, such as based on the face type of the face to which the vertex to be coded (e.g., encoded or decoded) belongs. For example, the first order of predictors (e.g., [pre d₂, pre d₃, pre d₁, pre d₄]) in the first subset of predictors may be determined based on the face degree (e.g., 3) of the first face. A second order of predictors (e.g., [pre d₄, pre d₃, pre d₂, pre d₁]) in a second subset of predictors from the list of candidate predictors may be determined based on a face degree of a second face in the first mesh. When the face degree of the second face is different from the face degree of the first face, the second order of predictors is different from the first order of predictors. In an example, the predictor list for a triangle face is [pre d₂, pre d₃, pre d₁, pre d₄], and the predictor list a quad face is [pre d₄, pre d₃, pre d₂, pre d₁]. In an example, a fourth order of predictors (e.g., [pre d₄, pre d₃, pre d₂, pre d₁]) in the first subset of predictors from the list of candidate predictors is determined based on the face degree of the second face in the first mesh. When the face degree of the second face is different from the face degree of the first face, the fourth order of predictors is different from the first order of predictors.

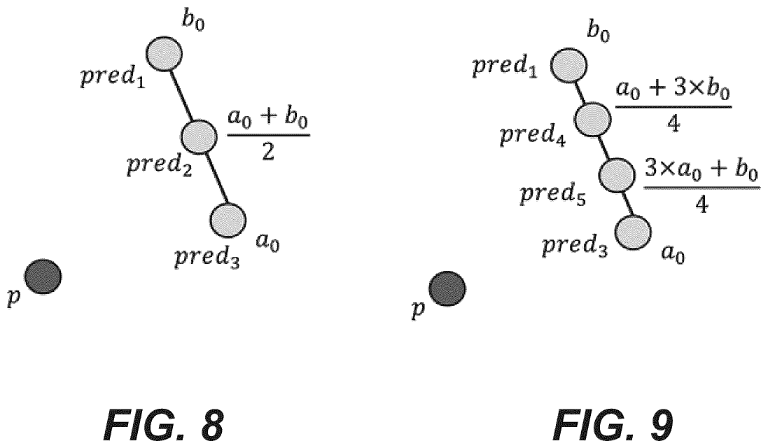

FIGS. 8-9 show examples of predicting a vertex p using two references a₀ and b₀. Depending on the mesh type, different predictors and/or different orders of the predictors may be used. Predictor selection and ordering for (i) a triangle mesh or a tri-quad mesh with the maximum face degree being 3 (FIG. 8) and (ii) a quad mesh or a tri-quad mesh with the maximum face degree being 4 (FIG. 9) are shown.

Referring to FIG. 8, for the triangle mesh or the tri-quad mesh with the maximum face degree being 3, 3 predictors [pre d₂, pre d₁, pre d₃] are used. In an example, pre d₁ is b₀, pre d₂ is (a₀+b₀)/2, and pre d₃ is a₀.

Referring to FIG. 9, for the quad mesh or the tri-quad mesh with the maximum face degree being 4, 4 predictors [pre d₁, pre d₄, pre d₅, pre d₃] are used. In an example, pre d₁ is b₀, pre d₄ is (a0+3b₀)/4, pre d₅ is (3a₀+b₀)/4, and pre d₃ is a₀.

Referring to FIGS. 8-9, two of the predictors pre d₁∧pre d₃ are the same between (i) the triangle mesh or the tri-quad mesh with the maximum face degree being 3 and (ii) the quad mesh or the tri-quad mesh with the maximum face degree being 4, and remaining predictor(s) are different. The orders in the respective predictor lists are different. For example, pre d₂ is on the top of the predictor list for the triangle mesh or the tri-quad mesh with the maximum face degree being 3, and pre d₁ is on the top of the predictor list for the quad mesh or the tri-quad mesh with the maximum face degree being 4.

In an aspect, an order of predictors in a predictor list (e.g., an order of the predictors in the first subset of predictors) may be updated, for example, after a specified refresh period. In an example, during coding of a mesh, the refresh period may be determined based on a number of vertices of the mesh. If the number of vertices of the mesh to be coded is L, the refresh period may be L/J, where J is an integer. For example, L is 2000, and J is 4, and the refresh period is 500. During the coding of the first 500 vertices, an order (e.g., a first order) of the predictors in the predictor list is used; after coding the first 500 vertices, the order of the predictors in the predictor list may be updated, and the updated order (e.g., a second order) of the predictors in the predictor list is used to code the next 500 vertices in the mesh. In an example, for the mesh having 2000 vertices to be coded, 4 different orders may be used.

In an aspect, frequently selected predictors may be kept on the top of the predictor list. For example, 4 predictors pre d₁, pre d₂, pre d₃, ∧pre d₄ are available. Initially, the predictor list is [pre d₁, pre d₂, pre d₃, pre d₄]. A list of predictor frequencies [fre qₚ₁, fre qₚ₂, fre qₚ₃, fre qₚ₄] corresponding to the 4 predictors pre d₁, pre d₂, pre d₃, ∧pre d₄ may be maintained. Initially, fre qₚᵢ is set to zero where i is from 1 to 4. Every time a vertex is coded (e.g., encoded or decoded), the frequency of the selected predictor is incremented by 1. For example, after the refresh period, the predictor frequencies are [100, 200, 250, 50] for pre d₁, pre d₂, pre d₃, ∧pre d₄. Thus, pre d₃ was the most frequently used followed by pre d₂, and then pre d₁. pre d₄ was the least frequently used in this example. As a result, the predictor list may be modified to [pre d₃, pre d₂, pre d₁, pre d₄] and the coding of the vertices continues. The predictor frequency list may be reset to zero after the refresh period or may be kept as it is. The refresh period may be fixed. The refresh period may vary and may be signaled in a bitstream.

In an example, the first order of predictors (e.g., [pre d₁, pre d₂, pre d₃, pre d₄] with pre d₁ being the first predictor pre d₄ being the last (or 4^{th}) predictor in the list) in the first subset of predictors used to predict the first attribute is determined based on the one of (i) the first mesh type of the first mesh and (ii) the first face type of the first face. The first attribute of a first set of vertices in the first mesh may be predicted based on the determined first order of predictors in the first subset of predictors, for example, during a refresh period. In an example, the first attribute of the first set of vertices in the first mesh is predicted based on the determined first order of predictors subsequent to the determining the first order of predictors. The first order of predictors in the first subset of predictors may be updated based on frequencies that the respective predictors in the first subset of predictors have been used to predict the first attribute of the first set of vertices in the first mesh, for example, during the refresh period. For example, the updated order may be [pre d₃, pre d₂, pre d₁, pre d₄]. The first attribute of a second set of vertices in the first mesh may be predicted based on the updated first order of predictors in the first subset of predictors, for example, during another refresh period.

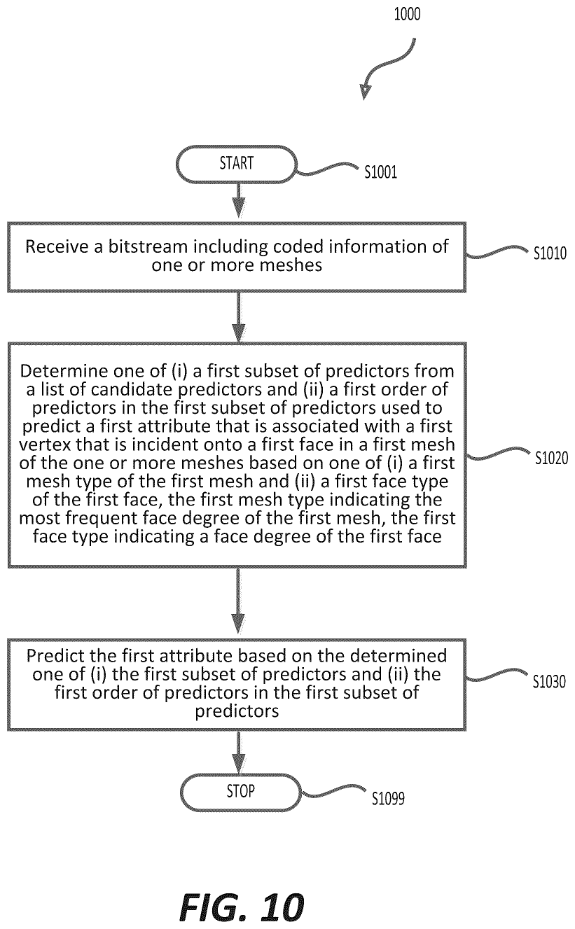

FIG. 10 shows a flow chart outlining a process (1000) according to an aspect of the disclosure. The process (1000) can be used in an apparatus. The apparatus may include a mesh decoder, such as a video decoder. The video decoder is configured to, for example, decode one or more meshes. In various aspects, the process (1000) is executed by processing circuitry, such as the processing circuitry that performs functions of the video decoder (110), the processing circuitry that performs functions of the video decoder (210), the mesh decoder, and/or the like. In some aspects, the process (1000) is implemented in software instructions, thus when the processing circuitry executes the software instructions, the processing circuitry performs the process (1000). The process starts at (S1001) and proceeds to (S1010).

At (S1010), a bitstream including coded information of the one or more meshes is received.

At (S1020), one of (i) a first subset of predictors from a list of candidate predictors and (ii) a first order of predictors in the first subset of predictors used to predict a first attribute that is associated with a first vertex that is incident onto a first face in a first mesh of the one or more meshes is determined based on one of (i) a first mesh type of the first mesh and (ii) a first face type of the first face. The first mesh type indicates the most frequent face degree of the first mesh. The first face type indicates a face degree of the first face.

In an example, the first subset of predictors is determined from the list of candidate predictors based on the first mesh type of the first mesh.

In an example, a face degree of each face in the first mesh is equal to the most frequent face degree of the first mesh.

In an example, a number of different face degrees of respective faces in the first mesh is greater than one, and the most frequent face degree of the first mesh has the highest occurrence in the face degrees of the respective faces in the first mesh.

In an example, the one or more meshes include the first mesh and a second mesh. A second subset of predictors is determined from the list of candidate predictors based on a second mesh type of the second mesh. When the second mesh type is different from the first mesh type, the second subset of predictors is different from the first subset of predictors.

In an example, the first subset of predictors is determined from the list of candidate predictors based on the face degree of the first face. In an example, a second subset of predictors is determined from the list of candidate predictors based on a face degree of a second face in the first mesh. When the face degree of the second face is different from the face degree of the first face, the second subset of predictors is different from the first subset of predictors.

In an example, the first order of predictors in the first subset of predictors is determined based on the first mesh type of the first mesh.

In an example, the one or more meshes include the first mesh and a second mesh. A second order of predictors in a second subset of predictors from the list of candidate predictors is determined based on a second mesh type of the second mesh. When the second mesh type is different from the first mesh type, the second order of predictors is different from the first order of predictors.

In an example, a third order of predictors in the first subset of predictors is determined based on the second mesh type of the second mesh. When the second mesh type is different from the first mesh type, the third order of predictors is different from the first order of predictors.

In an example, the first order of predictors in the first subset of predictors is determined based on the face degree of the first face.

In an example, a second order of predictors in a second subset of predictors from the list of candidate predictors is determined based on a face degree of a second face in the first mesh. When the face degree of the second face is different from the face degree of the first face, the second order of predictors is different from the first order of predictors.

In an example, a fourth order of predictors in the first subset of predictors from the list of candidate predictors is determined based on the face degree of the second face in the first mesh. When the face degree of the second face is different from the face degree of the first face, the fourth order of predictors is different from the first order of predictors.

At (S1030), the first attribute is predicted based on the determined one of (i) the first subset of predictors and (ii) the first order of predictors in the first subset of predictors.

Then, the process proceeds to (S1099) and terminates.

The process (1000) can be suitably adapted. Step(s) in the process (1000) can be modified and/or omitted. Additional step(s) can be added. Any suitable order of implementation can be used.

In an example, the first order of predictors in the first subset of predictors used to predict the first attribute is determined based on the one of (i) the first mesh type of the first mesh and (ii) the first face type of the first face. The first attribute of a first set of vertices in the first mesh is predicted based on the determined first order of predictors in the first subset of predictors. The first set of vertices includes the first vertex. The first order of predictors in the first subset of predictors is updated based on frequencies that the respective predictors in the first subset of predictors have been used to predict the first attribute of the first set of vertices in the first mesh. The first attribute of a second set of vertices in the first mesh is predicted based on the updated first order of predictors in the first subset of predictors.

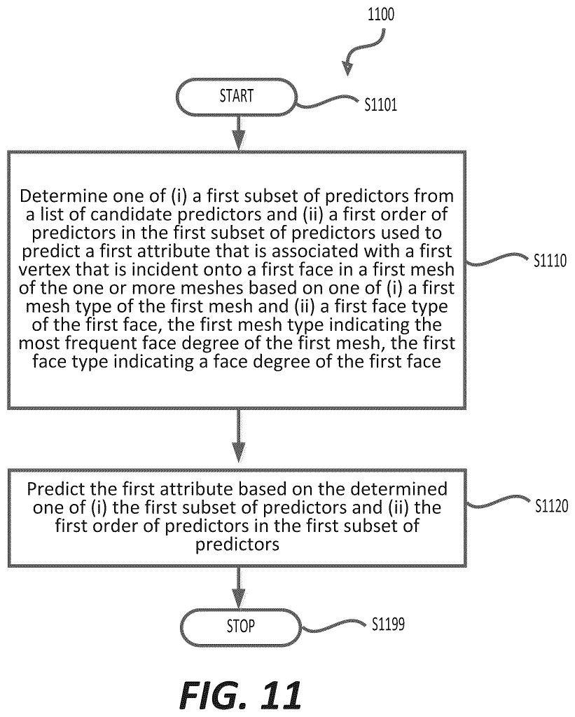

FIG. 11 shows a flow chart outlining a process (1100) according to an aspect of the disclosure. The process (1100) can be used in an apparatus. The apparatus may include a mesh encoder, such as a video encoder. The video encoder is configured to, for example, to encode one or more meshes. In various aspects, the process (1100) is executed by processing circuitry, such as the processing circuitry that performs functions of the video encoder (103), the processing circuitry that performs functions of the video encoder (303), the mesh encoder, and/or the like. In some aspects, the process (1100) is implemented in software instructions, thus when the processing circuitry executes the software instructions, the processing circuitry performs the process (1100). The process starts at (S1101) and proceeds to (S1110).

At (S1110), one of (i) a first subset of predictors from a list of candidate predictors and (ii) a first order of predictors in the first subset of predictors used to predict a first attribute that is associated with a first vertex that is incident onto a first face in a first mesh of the one or more meshes is determined based on one of (i) a first mesh type of the first mesh and (ii) a first face type of the first face. The first mesh type indicates the most frequent face degree of the first mesh. The first face type indicates a face degree of the first face.

At (S1120), the first attribute is predicted based on the determined one of (i) the first subset of predictors and (ii) the first order of predictors in the first subset of predictors.

Then, the process proceeds to (S1199) and terminates.

The process (1100) can be suitably adapted. Step(s) in the process (1100) can be modified and/or omitted. Additional step(s) can be added. Any suitable order of implementation can be used.

In an aspect, a method of processing one or more meshes includes processing a bitstream of the one or more meshes according to a format rule. For example, the bitstream is a bitstream that is decoded/encoded in any of the decoding and/or encoding methods described herein. The format rule may specify one or more constraints of the bitstream and/or one or more processes to be performed by the decoder and/or encoder.

In an aspect, the bitstream includes coded information of the one or more meshes. The format rule specifies that one of (i) a first subset of predictors from a list of candidate predictors and (ii) a first order of predictors in the first subset of predictors used to predict a first attribute that is associated with a first vertex that is incident onto a first face in a first mesh of the one or more meshes is determined based on one of (i) a first mesh type of the first mesh and (ii) a first face type of the first face. The first mesh type indicates the most frequent face degree of the first mesh. The first face type indicates a face degree of the first face. The format rule specifies that the first attribute is predicted based on the determined one of (i) the first subset of predictors and (ii) the first order of predictors in the first subset of predictors.

The methods, aspects, and examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

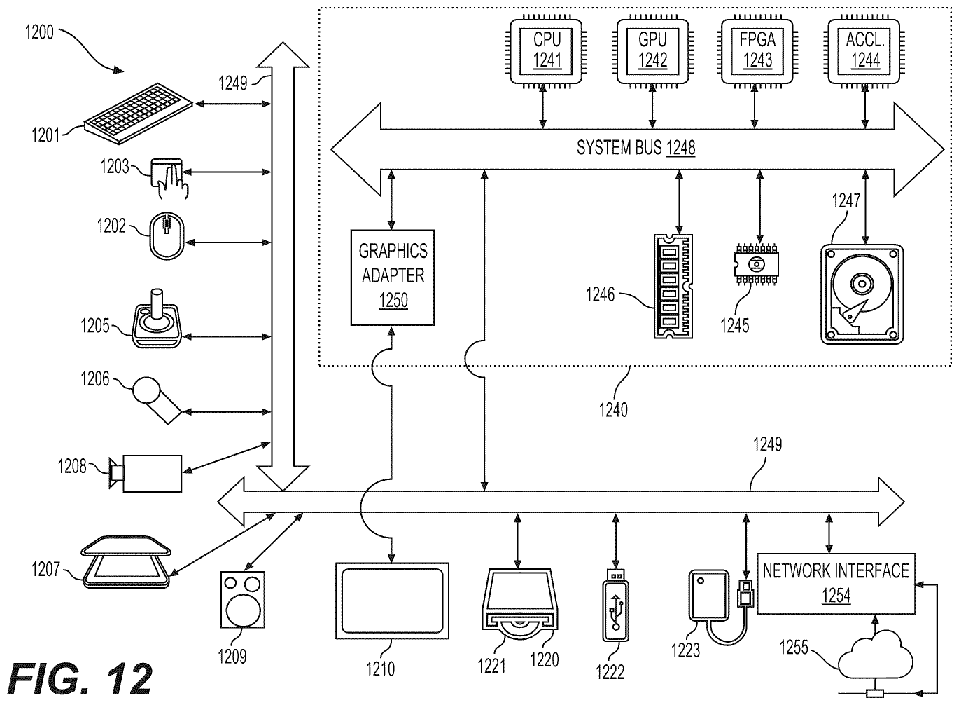

The techniques described above, can be implemented as computer software using computer-readable instructions and physically stored in one or more computer-readable media. For example, FIG. 12 shows a computer system (1200) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 12 for computer system (1200) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1200).

Computer system (1200) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1201), mouse (1202), trackpad (1203), touch screen (1210), data-glove (not shown), joystick (1205), microphone (1206), scanner (1207), camera (1208).

Computer system (1200) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1210), data-glove (not shown), or joystick (1205), but there can also be tactile feedback devices that do not serve as input devices), audio output devices (such as: speakers (1209), headphones (not depicted)), visual output devices (such as screens (1210) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1200) can also include human accessible storage devices and their associated media such as optical media including CD/DVD ROM/RW (1220) with CD/DVD or the like media (1221), thumb-drive (1222), removable hard drive or solid state drive (1223), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1200) can also include an interface (1254) to one or more communication networks (1255). Networks can for example be wireless, wireline, optical.

Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1249) (such as, for example USB ports of the computer system (1200)); others are commonly integrated into the core of the computer system (1200) by attachment to a system bus as described below (for example Ethernet interface into a PC computer system or cellular network interface into a smartphone computer system). Using any of these networks, computer system (1200) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1240) of the computer system (1200).

The core (1240) can include one or more Central Processing Units (CPU) (1241), Graphics Processing Units (GPU) (1242), specialized programmable processing units in the form of Field Programmable Gate Areas (FPGA) (1243), hardware accelerators for certain tasks (1244), graphics adapters (1250), and so forth. These devices, along with Read-only memory (ROM) (1245), Random-access memory (1246), internal mass storage such as internal non-user accessible hard drives, SSDs, and the like (1247), may be connected through a system bus (1248). In some computer systems, the system bus (1248) can be accessible in the form of one or more physical plugs to enable extensions by additional CPUs, GPU, and the like. The peripheral devices can be attached either directly to the core's system bus (1248), or through a peripheral bus (1249). In an example, the screen (1210) can be connected to the graphics adapter (1250). Architectures for a peripheral bus include PCI, USB, and the like.

CPUs (1241), GPUs (1242), FPGAs (1243), and accelerators (1244) can execute certain instructions that, in combination, can make up the aforementioned computer code. That computer code can be stored in ROM (1245) or RAM (1246). Transitional data can also be stored in RAM (1246), whereas permanent data can be stored for example, in the internal mass storage (1247). Fast storage and retrieve to any of the memory devices can be enabled through the use of cache memory, that can be closely associated with one or more CPU (1241), GPU (1242), mass storage (1247), ROM (1245), RAM (1246), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1200), and specifically the core (1240) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1240) that are of non-transitory nature, such as core-internal mass storage (1247) or ROM (1245). The software implementing various aspects of the present disclosure can be stored in such devices and executed by core (1240). A computer-readable medium can include one or more memory devices or chips, according to particular needs. The software can cause the core (1240) and specifically the processors therein (including CPU, GPU, FPGA, and the like) to execute particular processes or particular parts of particular processes described herein, including defining data structures stored in RAM (1246) and modifying such data structures according to the processes defined by the software. In addition or as an alternative, the computer system can provide functionality as a result of logic hardwired or otherwise embodied in a circuit (for example: accelerator (1244)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1) A method for decoding one or more meshes, the method including: receiving a bitstream including coded information of the one or more meshes; determining one of (i) a first subset of predictors from a list of candidate predictors and (ii) a first order of predictors in the first subset of predictors used to predict a first attribute that is associated with a first vertex that is incident onto a first face in a first mesh of the one or more meshes based on one of (i) a first mesh type of the first mesh and (ii) a first face type of the first face, the first mesh type indicating the most frequent face degree of the first mesh, the first face type indicating a face degree of the first face; and predicting the first attribute based on the determined one of (i) the first subset of predictors and (ii) the first order of predictors in the first subset of predictors.
(2) The method of feature (1), in which the determining includes: determining the first subset of predictors from the list of candidate predictors based on the first mesh type of the first mesh.
(3) The method of feature (1) or (2), in which a face degree of each face in the first mesh is equal to the most frequent face degree of the first mesh.
(4) The method of any of features (1) to (2), in which a number of different face degrees of respective faces in the first mesh is greater than one, and the most frequent face degree of the first mesh has the highest occurrence in the face degrees of the respective faces in the first mesh.
(5) The method of any of features (1) to (4), in which the one or more meshes include the first mesh and a second mesh; the method further includes determining a second subset of predictors from the list of candidate predictors based on a second mesh type of the second mesh; and when the second mesh type is different from the first mesh type, the second subset of predictors is different from the first subset of predictors.
(6) The method of feature (1), in which the determining includes determining the first subset of predictors from the list of candidate predictors based on the face degree of the first face.
(7) The method of feature (6), in which the method further includes determining a second subset of predictors from the list of candidate predictors based on a face degree of a second face in the first mesh; and when the face degree of the second face is different from the face degree of the first face, the second subset of predictors is different from the first subset of predictors.
(8) The method of feature (1), in which the determining includes determining the first order of predictors in the first subset of predictors based on the first mesh type of the first mesh.
(9) The method of feature (8), in which a face degree of each face in the first mesh is equal to the most frequent face degree of the first mesh.
(10) The method of feature (8), in which a number of different face degrees of respective faces in the first mesh is greater than one, and the most frequent face degree of the first mesh has the highest occurrence in the face degrees of the respective faces in the first mesh.
(11) The method of feature (8), in which the one or more meshes include the first mesh and a second mesh; the method further includes determining a second order of predictors in a second subset of predictors from the list of candidate predictors based on a second mesh type of the second mesh; and when the second mesh type is different from the first mesh type, the second order of predictors is different from the first order of predictors.
(12) The method of feature (1), in which the determining includes determining the first order of predictors in the first subset of predictors based on the face degree of the first face.
(13) The method of feature (12), in which the method further includes determining a second order of predictors in a second subset of predictors from the list of candidate predictors based on a face degree of a second face in the first mesh; and when the face degree of the second face is different from the face degree of the first face, the second order of predictors is different from the first order of predictors.
(14) The method of feature (1), in which the determining includes determining the first order of predictors in the first subset of predictors used to predict the first attribute based on the one of (i) the first mesh type of the first mesh and (ii) the first face type of the first face; and the method includes predicting the first attribute of a first set of vertices in the first mesh based on the determined first order of predictors in the first subset of predictors, the first set of vertices including the first vertex, updating the first order of predictors in the first subset of predictors based on frequencies that the respective predictors in the first subset of predictors have been used to predict the first attribute of the first set of vertices in the first mesh, and predicting the first attribute of a second set of vertices in the first mesh based on the updated first order of predictors in the first subset of predictors
(15) A method for encoding one or more meshes, the method including: determining one of (i) a first subset of predictors from a list of candidate predictors and (ii) a first order of predictors in the first subset of predictors used to predict a first attribute that is associated with a first vertex that is incident onto a first face in a first mesh of the one or more meshes based on one of (i) a first mesh type of the first mesh and (ii) a first face type of the first face, the first mesh type indicating the most frequent face degree of the first mesh, the first face type indicating a face degree of the first face; and predicting the first attribute based on the determined one of (i) the first subset of predictors and (ii) the first order of predictors in the first subset of predictors.
(16) The method of feature (15), in which the determining includes determining the first subset of predictors from the list of candidate predictors based on the first mesh type of the first mesh.
(17) The method of feature (15), in which the determining includes determining the first subset of predictors from the list of candidate predictors based on the face degree of the first face.
(18) The method of feature (15), in which the determining includes determining the first order of predictors in the first subset of predictors based on the first mesh type of the first mesh.
(19) The method of feature (15), in which the determining includes determining the first order of predictors in the first subset of predictors based on the face degree of the first face.
(20) A method of processing one or more meshes, and the method includes processing a bitstream of the one or more meshes according to a format rule. The bitstream includes coded information of the one or more meshes. The format rule specifies that one of (i) a first subset of predictors from a list of candidate predictors and (ii) a first order of predictors in the first subset of predictors used to predict a first attribute that is associated with a first vertex that is incident onto a first face in a first mesh of the one or more meshes is determined based on one of (i) a first mesh type of the first mesh and (ii) a first face type of the first face, the first mesh type indicating the most frequent face degree of the first mesh, the first face type indicating a face degree of the first face; and the first attribute is predicted based on the determined one of (i) the first subset of predictors and (ii) the first order of predictors in the first subset of predictors.
(21) An apparatus for video decoding, including processing circuitry that is configured to perform the method of any of features (1) to (14).
(22) An apparatus for video encoding, including processing circuitry that is configured to perform the method of any of features (15) to (19).
(23) An apparatus for processing one or more meshes, including processing circuitry that is configured to perform the method of feature (20).
(24) A non-transitory computer-readable storage medium storing instructions which when executed by at least one processor cause the at least one processor to perform the method of any of features (1) to (20).

What is claimed is:

1. A method for decoding one or more meshes, the method comprising:
receiving a bitstream including coded information of the one or more meshes;
determining one of (i) a first subset of predictors from a list of candidate predictors and (ii) a first order of predictors in the first subset of predictors used to predict a first attribute that is associated with a first vertex that is incident onto a first face in a first mesh of the one or more meshes based on one of (i) a first mesh type of the first mesh and (ii) a first face type of the first face, the first mesh type indicating the most frequent face degree of the first mesh, the first face type indicating a face degree of the first face; and
predicting the first attribute based on the determined one of (i) the first subset of predictors and (ii) the first order of predictors in the first subset of predictors.

2. The method of claim 1, wherein the determining comprises:
determining the first subset of predictors from the list of candidate predictors based on the first mesh type of the first mesh.

3. The method of claim 2, wherein a face degree of each face in the first mesh is equal to the most frequent face degree of the first mesh.

4. The method of claim 2, wherein a number of different face degrees of respective faces in the first mesh is greater than one, and the most frequent face degree of the first mesh has the highest occurrence in the face degrees of the respective faces in the first mesh.

5. The method of claim 2, wherein
the one or more meshes include the first mesh and a second mesh;
the method further includes determining a second subset of predictors from the list of candidate predictors based on a second mesh type of the second mesh; and
when the second mesh type is different from the first mesh type, the second subset of predictors is different from the first subset of predictors.

6. The method of claim 1, wherein the determining comprises:
determining the first subset of predictors from the list of candidate predictors based on the face degree of the first face.

7. The method of claim 6, wherein
the method further includes determining a second subset of predictors from the list of candidate predictors based on a face degree of a second face in the first mesh; and
when the face degree of the second face is different from the face degree of the first face, the second subset of predictors is different from the first subset of predictors.

8. The method of claim 1, wherein the determining comprises:
determining the first order of predictors in the first subset of predictors based on the first mesh type of the first mesh.

9. The method of claim 8, wherein a face degree of each face in the first mesh is equal to the most frequent face degree of the first mesh.

10. The method of claim 8, wherein a number of different face degrees of respective faces in the first mesh is greater than one, and the most frequent face degree of the first mesh has the highest occurrence in the face degrees of the respective faces in the first mesh.

11. The method of claim 8, wherein
the one or more meshes include the first mesh and a second mesh;
the method further includes determining a second order of predictors in a second subset of predictors from the list of candidate predictors based on a second mesh type of the second mesh; and
when the second mesh type is different from the first mesh type, the second order of predictors is different from the first order of predictors.

12. The method of claim 1, wherein the determining comprises:
determining the first order of predictors in the first subset of predictors based on the face degree of the first face.

13. The method of claim 12, wherein
the method further includes determining a second order of predictors in a second subset of predictors from the list of candidate predictors based on a face degree of a second face in the first mesh; and
when the face degree of the second face is different from the face degree of the first face, the second order of predictors is different from the first order of predictors.

14. The method of claim 1, wherein
the determining includes determining the first order of predictors in the first subset of predictors used to predict the first attribute based on the one of (i) the first mesh type of the first mesh and (ii) the first face type of the first face; and
the method includes
predicting the first attribute of a first set of vertices in the first mesh based on the determined first order of predictors in the first subset of predictors, the first set of vertices including the first vertex,
updating the first order of predictors in the first subset of predictors based on frequencies that the respective predictors in the first subset of predictors have been used to predict the first attribute of the first set of vertices in the first mesh, and
predicting the first attribute of a second set of vertices in the first mesh based on the updated first order of predictors in the first subset of predictors.

15. A method for encoding one or more meshes, the method comprising:
determining one of (i) a first subset of predictors from a list of candidate predictors and (ii) a first order of predictors in the first subset of predictors used to predict a first attribute that is associated with a first vertex that is incident onto a first face in a first mesh of the one or more meshes based on one of (i) a first mesh type of the first mesh and (ii) a first face type of the first face, the first mesh type indicating the most frequent face degree of the first mesh, the first face type indicating a face degree of the first face; and
predicting the first attribute based on the determined one of (i) the first subset of predictors and (ii) the first order of predictors in the first subset of predictors.

16. The method of claim 15, wherein the determining comprises:
determining the first subset of predictors from the list of candidate predictors based on the first mesh type of the first mesh.

17. The method of claim 15, wherein the determining comprises:
determining the first subset of predictors from the list of candidate predictors based on the face degree of the first face.

18. The method of claim 15, wherein the determining comprises:
determining the first order of predictors in the first subset of predictors based on the first mesh type of the first mesh.

19. The method of claim 15, wherein the determining comprises:
determining the first order of predictors in the first subset of predictors based on the face degree of the first face.

20. A method of processing one or more meshes, the method comprising:
processing a bitstream of the one or more meshes according to a format rule,
the bitstream includes coded information of the one or more meshes, and
the format rule specifies that
one of (i) a first subset of predictors from a list of candidate predictors and (ii) a first order of predictors in the first subset of predictors used to predict a first attribute that is associated with a first vertex that is incident onto a first face in a first mesh of the one or more meshes is determined based on one of (i) a first mesh type of the first mesh and (ii) a first face type of the first face, the first mesh type indicating the most frequent face degree of the first mesh, the first face type indicating a face degree of the first face; and
the first attribute is predicted based on the determined one of (i) the first subset of predictors and (ii) the first order of predictors in the first subset of predictors.
